(19) United States
(12) Patent Application Publication
(10) Pub. No.: US 2025/0297505 A1
(43) Pub. Date: Sep. 25, 2025

(54) CONVERTIBLE DUAL-ZONE OVEN MECHANISM

(71) Applicant: The Steelstone Group LLC, Brooklyn, NY (US)

(72) Inventors: Naphtali H. Biegeleisen, Brooklyn, NY (US); Binyumen Itzkowitz, Brooklyn, NY (US); Meilech Friedman, Linden, NJ (US); Kalman Wertzberger, Brooklyn, NY (US); Robyn De Luca, Queens, NY (US); Wenhui Huang, Brooklyn, NY (US); Joseph Deutsch, Brooklyn, NY (US)

(21) Appl. No.: 19/085,748

(22) Filed: Mar. 20, 2025

Related U.S. Application Data
(60) Provisional application No. 63/568,270, filed on Mar. 21, 2024.

(51) Int. Cl. E05F 11/20; F24C 15/00; F24C 15/02

(52) U.S. Cl. CPC E05F 11/20; F24C 15/007; F24C 15/02; E05Y 2201/214; E05Y 2900/308

(57) ABSTRACT

A cooking appliance includes a housing having a primary internal cavity and two doors for closing an opening of the primary internal cavity. Each door has a hinged outer edge at which the corresponding door pivots relative to the housing. The appliance also has a door synchronizing mechanism for linking the two doors, thereby synchronizing the opening or closing of the two doors when the door synchronizing mechanism is engaged, and a removable divider for dividing the primary internal cavity into a first divided internal cavity and a second divided internal cavity. In a first configuration, the removable divider is present and the door synchronizing mechanism is disengaged such that the two doors open and close independently, and in a second configuration, the removable divider is removed and the door synchronizing mechanism is engaged.

### CROSS-REFERENCE TO RELATED APPLICATIONS

This application claims the benefit of U.S. Provisional Application No. 63/568,270, filed Mar. 21, 2024, the entire contents of which are incorporated by reference herein.

### FIELD

The present disclosure generally relates to a convertible dual-zone oven having a first configuration in which a single oven cavity is provided and a second configuration in which the single oven cavity is divided into two zones. In particular, the disclosure relates to synchronized French door mechanisms for use in a convertible dual-zone oven.

### BACKGROUND

Kitchen appliances may be provided with a variety of door types. In the case of ovens, an oven enclosure is typically closed by a traditional single door that pivots downwards about a horizontal axis. That is, in a typical oven the oven door is pulled outwards from an oven enclosure and is lowered into a substantially horizontal position to provide access to an interior of the oven. When closed, the single oven door covers an opening of the enclosure.

Such a traditional oven door has some disadvantages, such as the distance from the oven that such a door must extend when open and the interference of such an oven door with easy access to the oven enclosure, or cavity. Alternatively, some ovens incorporate horizontally opening doors, such as French doors. Such French door systems typically include two doors hinged at outer edges of an opening of the oven enclosure, and may include mechanisms for synchronizing the opening of the two doors, so that if one door is opened by a user, both oven doors open.

Ovens may be provided in various sizes, with larger ovens providing some benefits and smaller ovens providing other benefits. For example, larger ovens have additional capacity, while smaller ovens require less energy and may heat up faster, while providing better or more easily controlled temperature gradients and airflow circulation. Accordingly, a larger oven may provide additional benefits by providing a mechanism for subdividing the oven into smaller oven cavities, such that the smaller oven cavities can provide the benefits associated with a smaller oven.

A conversion of a large oven into multiple smaller ovens within a single oven cavity is associated with various complications. For example, if French doors are synchronized in the context of a large oven cavity, a user would be forced to open both doors when either smaller oven is opened. Similarly, control systems and heating elements would need to be configured to account for such a conversion. Accordingly, there is a need for improvements to convertible dual-zone oven mechanisms, particularly in the context of ovens with French door configurations.

### SUMMARY

A cooking appliance is provided including a housing having a primary internal cavity and two doors for closing an opening of the primary internal cavity. Each door has a hinged outer edge at which the corresponding door pivots relative to the housing.

The appliance also has a door synchronizing mechanism for linking the two doors, thereby synchronizing the opening or closing of the two doors when the door synchronizing mechanism is engaged, and a removable divider for dividing the primary internal cavity into a first divided internal cavity and a second divided internal cavity. In a first configuration, the removable divider is present and the door synchronizing mechanism is disengaged such that the two doors open and close independently, and in a second configuration, the removable divider is removed and the door synchronizing mechanism is engaged.

In some embodiments, insertion of the removable divider triggers or executes a transition of the cooking appliance from the second configuration to the first configuration, and removal of the removable divider triggers or executes a transition of the cooking appliance from the first configuration to the second configuration.

In some such embodiments, insertion of the removable divider physically decouples mechanical components to disengage the door synchronizing mechanism. In some such embodiments, the door synchronizing mechanism includes a central linkage linking a first rigid elongated element extending towards the hinged outer edge of the first door and a second rigid elongated element extending towards the hinged outer edge of the second door. At least one of the first hinged outer edge and the second hinged outer edge then includes an engagement element for receiving and engaging with the corresponding rigid elongated element, and the insertion of the removable divider disengages the door synchronizing mechanism by decoupling the corresponding rigid elongated element from the corresponding engagement element.

In some such embodiments, one of the rigid elongated element and the corresponding engagement element is a primary coupling element and rests above a secondary coupling element comprising the other of the rigid elongated element. The corresponding engagement element and the primary coupling element then includes a tab for engaging a slot in the secondary coupling element, such that the primary coupling element engages the secondary coupling element gravitationally when unobstructed, thereby coupling the corresponding rigid elongated element and the corresponding engagement element.

In some such embodiments, the primary coupling element includes a sleeve for at least partially enclosing and allowing for translation of the secondary coupling element when not coupled.

In some such embodiments, the cooking appliance includes a lifting element for lifting the primary coupling element relative to the secondary coupling element upon insertion of the removable divider. In some such embodiments, the primary coupling elements includes a sleeve for at least partially enclosing and allowing for translation of the secondary coupling element when not coupled. The lifting element is then positioned below both the primary coupling element and the secondary coupling element and lifts the primary coupling element through contact with the sleeve.

In some embodiments using a lifting element, the lifting element is a rotating blade which is mechanically rotated into a lifting configuration by a portion of the removable divider upon insertion of the removable divider.

In some such embodiments both the first and second rigid elongated elements couple with the corresponding engagement elements, and the lifting element includes two rotatable blades arranged substantially symmetrically such that both primary coupling elements are decoupled from the corresponding secondary coupling elements upon insertion of the removable divider.

In some embodiments utilizing a rotatable blade, the rotatable blade is biased against the lifting configuration, such that the rotatable blade rotates away from the lifting configuration when not retained by the presence of the removable divider.

In some embodiments, the cooking appliance includes electronic circuitry for controlling cooking operation of the cooking appliance. The cooking appliance determines whether the removable divider is present within primary internal cavity thereby determining whether the cooking appliance is in the first configuration or the second configuration and, upon determining that the cooking appliance is in the first configuration, the electronic circuitry operates the first divided internal cavity and the second divided internal cavity independently.

In some such embodiments, the cooking appliance includes a first heating element within the first divided internal cavity and a second heating element within the first divided internal cavity. Upon determining that the cooking appliance is in the first configuration, the electronic circuitry independently controls the first heating element and the second heating element.

In some such embodiments, the cooking appliance includes a first air circulation fan within or associated with the first divided internal cavity and a second air circulation fan within or associated with the second divided internal cavity. Upon determining that the cooking appliance is in the first configuration, the electronic circuitry independently controls the first air circulation fan and the second air circulation fan.

In some embodiments utilizing two distinct heating elements, upon determining that the cooking appliance is in the second configuration, the electronic circuitry controls the first heating element and the second heating element in concert to regulate a temperature of the primary internal cavity.

Also provided is a method for converting a cooking appliance between single oven and double oven configurations. The method includes providing a cooking appliance having a housing with a primary internal cavity, providing two doors for closing an opening of the primary internal cavity of the cooking appliance, each door having a hinged outer edge at which the corresponding door pivots relative to the housing, and providing a door synchronizing mechanism for linking the two doors, thereby synchronizing the opening or closing of the two doors when the door synchronizing mechanism is engaged.

The method then proceeds with providing a removable divider for dividing the primary internal cavity into a first divided internal cavity and a second divided internal cavity, inserting the removable divider within the primary internal cavity such that a portion of the removable divider impacts a component of the door synchronizing mechanism, and such that the removable divider divides the primary internal cavity into a first divided internal cavity and a second divided internal cavity, and decoupling the door synchronizing mechanism as a result of the impact of the removable divider.

A user then opens or closes a first door of the two doors independently of a second door of the two doors.

In some such embodiments, the door synchronizing mechanism further includes at least one rotatable decoupling blade having a decoupling configuration in which the door synchronizing mechanism is decoupled and a coupling configuration in which the door synchronizing mechanism is coupled. The decoupling blade is biased towards the coupling configuration, and the portion of the removable divider impacts an extension of the at least one rotatable decoupling blade, thereby rotating the decoupling blade into the decoupling configuration.

### BRIEF DESCRIPTION OF THE DRAWINGS

FIG. 1 shows a cooking appliance in accordance with this disclosure.

FIG. 2 shows the cooking appliance of FIG. 1 in a first configuration and with doors opened.

FIG. 3 shows the cooking appliance of FIG. 1 in a second configuration and with doors opened.

FIG. 4 shows a perspective view of the cooking appliance of FIG. 1 in the first configuration and with an outer housing removed.

FIG. 5 shows a top view of the cooking appliance of FIG. 1 in the first configuration and with the outer housing removed.

FIG. 6 shows a top perspective view of the cooking appliance of FIG. 1 in the second configuration with the doors opened and with the outer housing removed.

FIG. 7 shows a portion of a door synchronizing mechanism of the cooking appliance of FIG. 1 in the second configuration.

FIG. 8 shows a top perspective view of the cooking appliance of FIG. 1 transitioning from the second configuration to the first configuration with the doors opened and with the outer housing removed.

FIG. 9 shows a top perspective view of the cooking appliance of FIG. 1 in the first configuration with the doors opened and with the outer housing removed.

FIG. 10 shows a portion of the door synchronizing mechanism of the cooking appliance of FIG. 7 in the first configuration.

FIG. 11 shows a top perspective view of the cooking appliance of FIG. 1 in the first configuration with one door open.

FIGS. 12 and 13 show a portion of the door synchronizing mechanism of FIG. 7 in the second configuration.

FIG. 14 shows the portion of the door synchronizing mechanism of FIG. 7 in the first configuration.

FIG. 15 shows the portion of the door synchronizing mechanism of FIG. 7 in the first configuration with components separated.

FIGS. 16 and 17 show the cooking appliance of FIG. 1 with the doors and outer housing removed.

FIG. 18 shows a sectioned view of the cooking appliance of FIG. 1.

FIG. 19 shows a perspective view of the cooking appliance of FIG. 1 with the outer housing removed.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

A convertible cooking appliance, such as an oven, provides an internal cavity for cooking that can be provided in two configurations. A first configuration utilizes a removable divider to divide the oven in half to provide two discrete oven spaces. A second configuration provides the internal cavity as a single oven space with the removable divider removed. The internal cavity is closed off by a pair of doors provided as French doors. In the first configuration, the doors open independently to provide access to the two discrete oven spaces, while in the second configuration, the doors are synchronized such that opening either door opens both doors by way of a synchronizing mechanism.

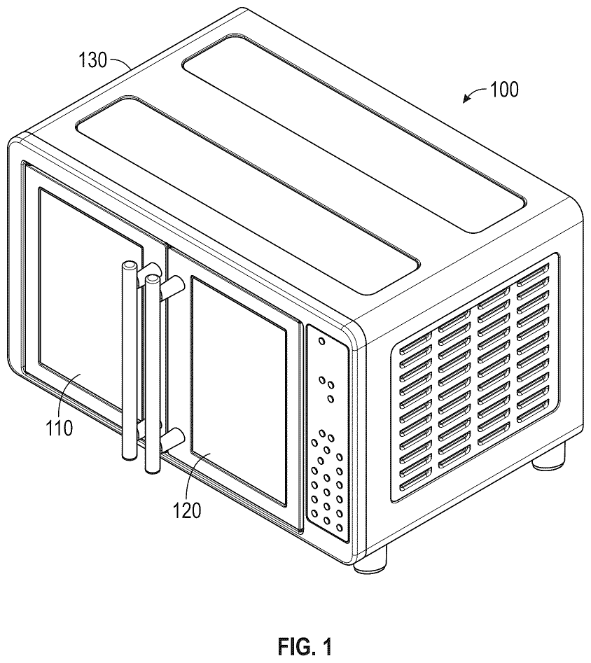

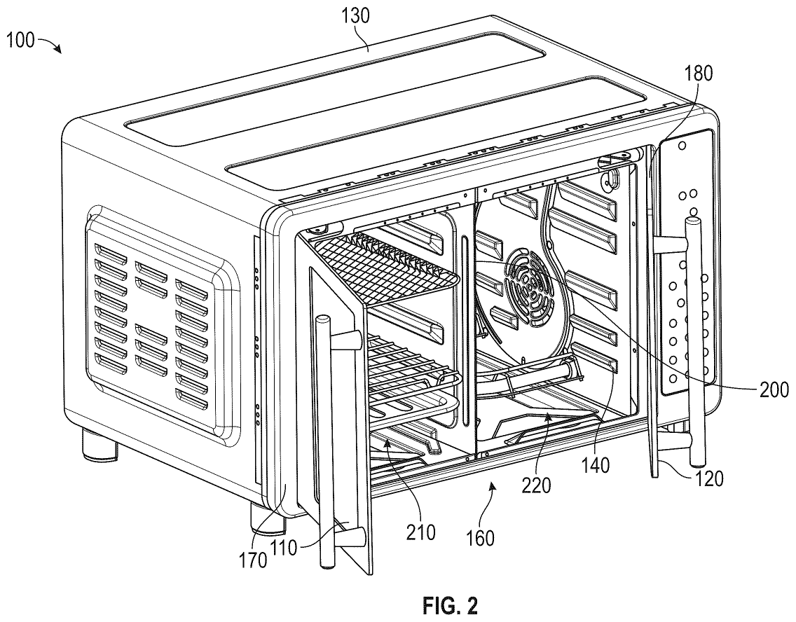

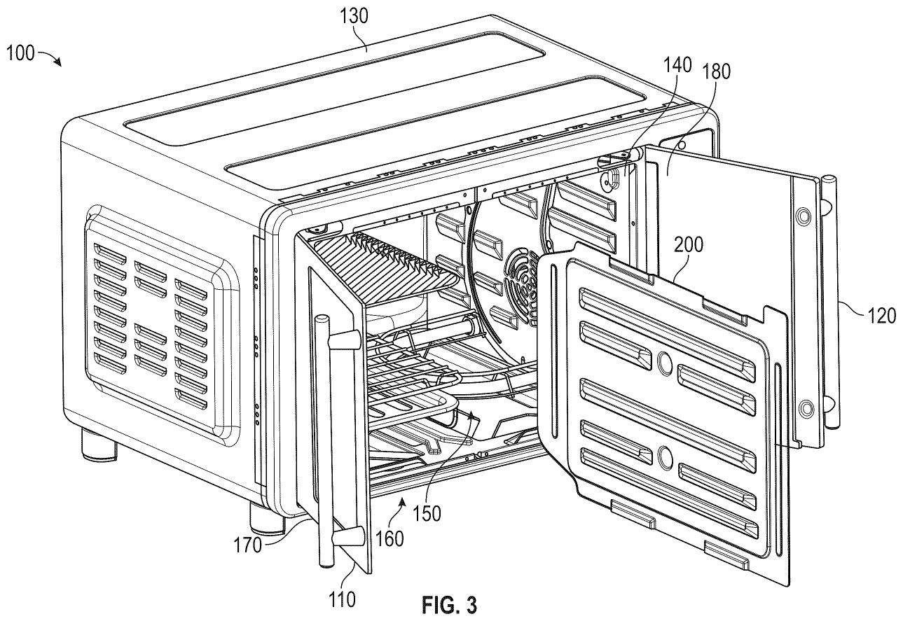

FIG. 1 shows a cooking appliance 100 in accordance with this disclosure. FIG. 2 shows the cooking appliance 100 of FIG. 1 in a first configuration and with doors 110, 120 opened. FIG. 3 shows the cooking appliance 100 of FIG. 1 in a second configuration and with doors 110, 120 opened.

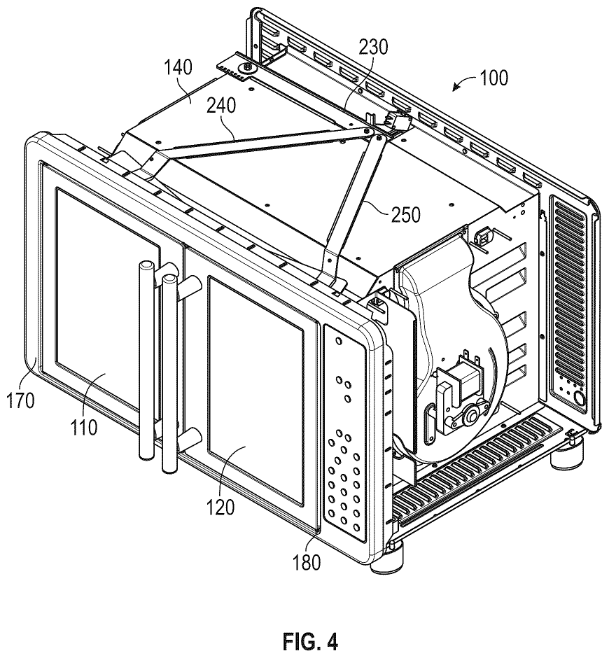

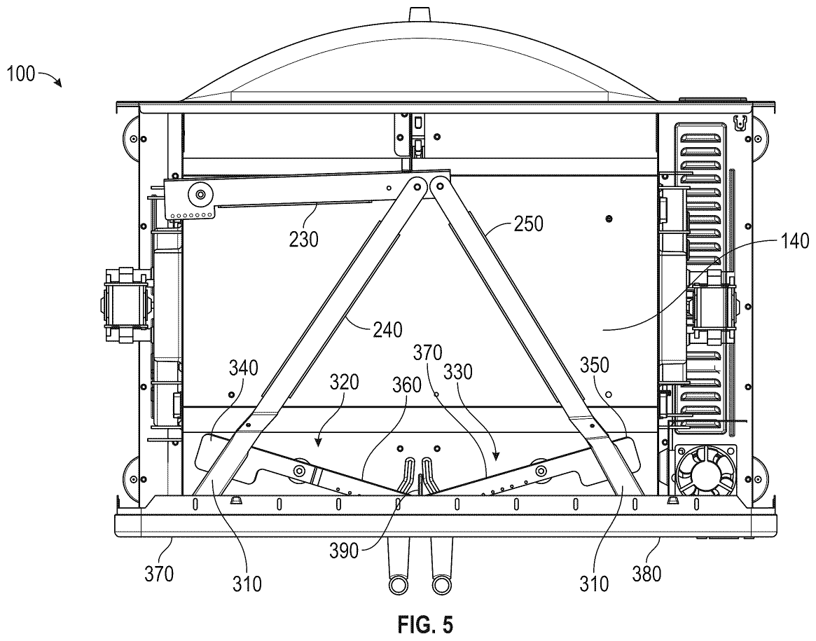

FIG. 4 shows a perspective view of the cooking appliance 100 of FIG. 1 in the first configuration and with an outer housing removed 130. FIG. 5 shows a top view of the cooking appliance 100 of FIG. 1 in the first configuration and with the outer housing 130 removed.

As shown, the cooking appliance 100 has an outer housing 130 that encloses the appliance and an inner housing 140, the inner and outer housings together defining a housing 130, 140 for the appliance.

The housing 130, 140 has a primary internal cavity 150 defined by the inner housing 140. The primary inner cavity 150 is a cooking cavity which typically functions as an oven when the cooking appliance 100 is in the second configuration as shown in FIG. 3.

The cooking appliance 100 further includes two doors 110, 120 for closing an opening 160 of the primary internal cavity 150, with each door having a respective hinged outer edge 170, 180 at which the corresponding door pivots relative to the housing 130, 140. A door synchronizing mechanism 190 links the two doors 110, 120, thereby synchronizing the opening or closing of the two doors when the door synchronizing mechanism is engaged.

The cooking appliance 100 is then provided with a removable divider 200 for dividing the primary internal cavity 150 into a first divided internal cavity 210 and a second divided internal cavity 220. In the embodiment shown, the removable divider 200 is centrally located within the primary internal cavity 150, such that the first divided internal cavity is approximately the same size as the second divided internal cavity 220. The doors 110, 120 are similarly approximately the same size as each other, such that the first divided internal cavity 210 is adjacent to and closable by the first door 110 and the second divided internal cavity 220 is adjacent to and closable by the second door 120. It is understood that the cooking appliance 100 may instead be configured such that the removable divider 200 divides the primary internal cavity 150 into differently sized divided internal cavities. In such a configuration, the doors may remain similarly sized, such as in the embodiment shown, or the doors may instead be sized to correspond to the widths of the resulting internal cavities.

When the cooking appliance 100 is in a first configuration, such as that shown in FIG. 2, the removable divider 200 is present within the primary internal cavity 150 and divides the cavity into the first and second divided internal cavities 210, 220. Further, the door synchronizing mechanism 190 is disengaged, such that the two doors 110, 120 open and close independently. The first door 110 may then be opened in order to provide access to the first divided internal cavity 210 without also opening the second door, thereby keeping the second divided internal cavity 220 closed.

When the cooking appliance 100 is in a second configuration, the removable divider 200 is removed and the door synchronizing mechanism 190 is engaged, such that the doors 110, 120 are synchronized and opening either door fully opens the primary internal cavity 150. As shown, the door synchronizing mechanism 190 may be located in between the inner and outer housings 130, 140.

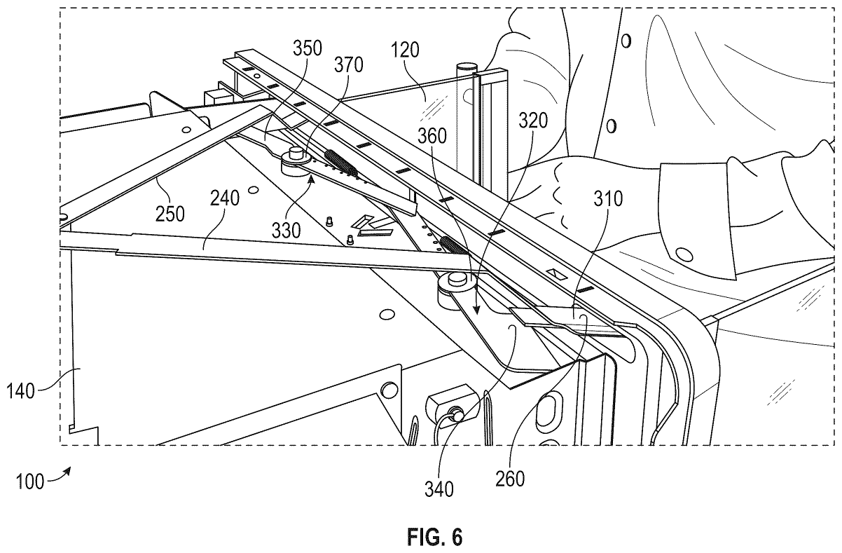

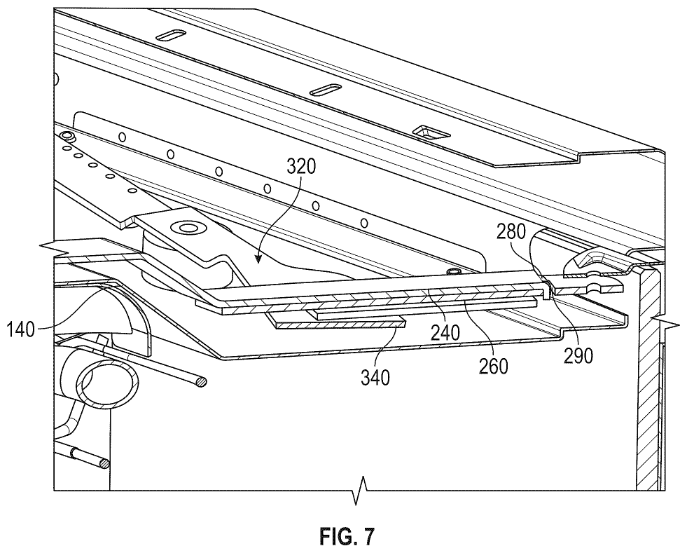

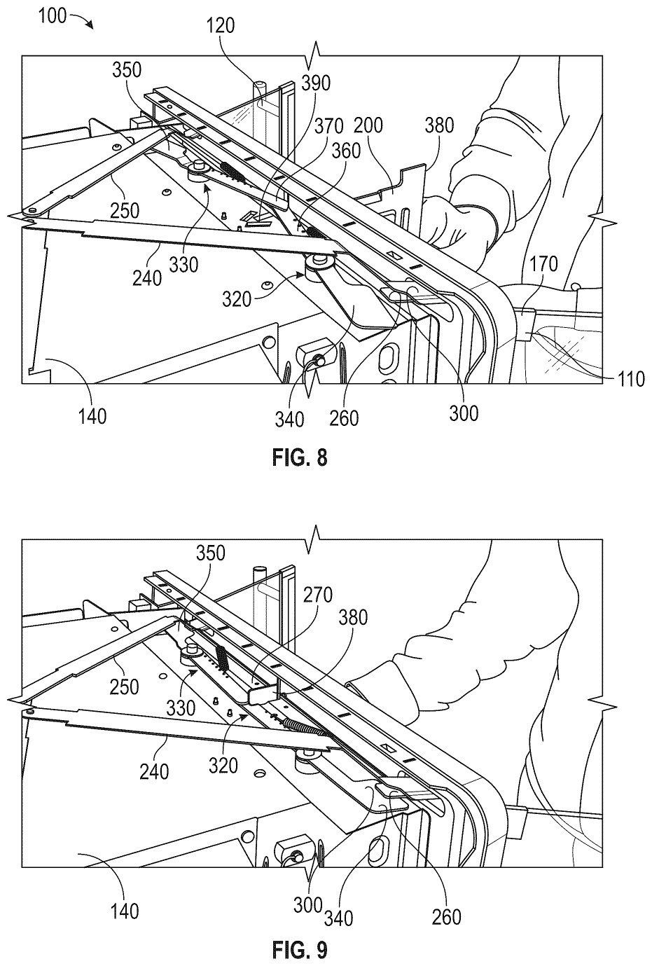

FIG. 6 shows a top perspective view of the cooking appliance 100 of FIG. 1 in the second configuration with the doors 110, 120 opened and with the outer housing 130 removed. FIG. 7 shows a portion of a door synchronizing mechanism 190 of the cooking appliance 100 of FIG. 1 in the second configuration. FIG. 8 shows a top perspective view of the cooking appliance 100 of FIG. 1 transitioning from the second configuration to the first configuration with the doors 110, 120 opened and with the outer housing 130 removed.

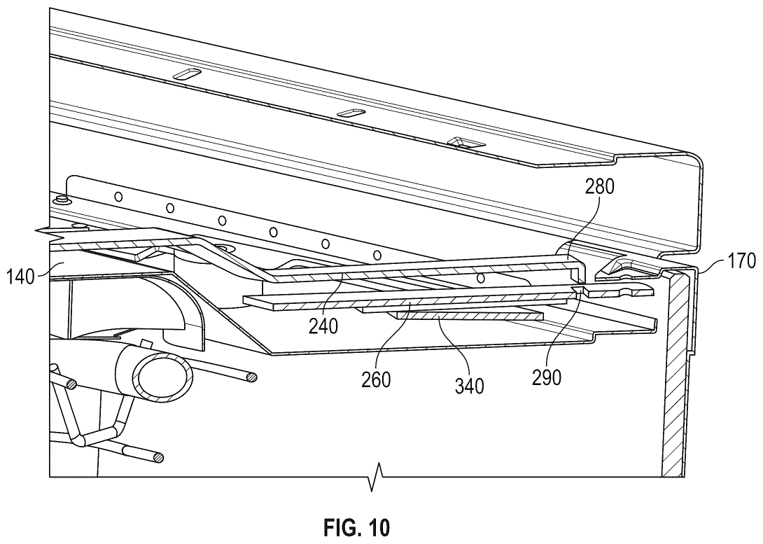

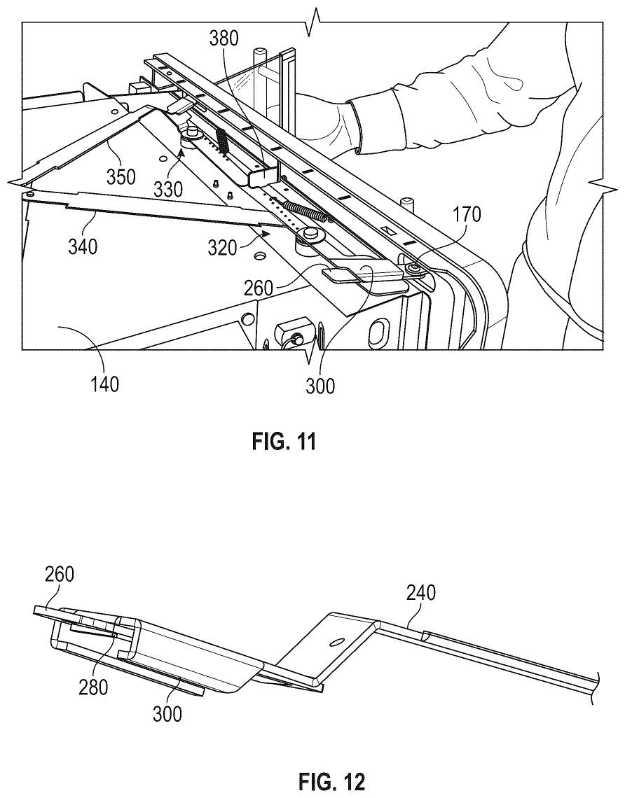

FIG. 9 shows a top perspective view of the cooking appliance 100 of FIG. 1 in the first configuration with the doors 110, 120 opened and with the outer housing 130 removed. FIG. 10 shows a portion of the door synchronizing mechanism 190 of the cooking appliance 100 of FIG. 7 in the first configuration. FIG. 11 shows a top perspective view of the cooking appliance 100 of FIG. 1 in the first configuration with one door 120 open.

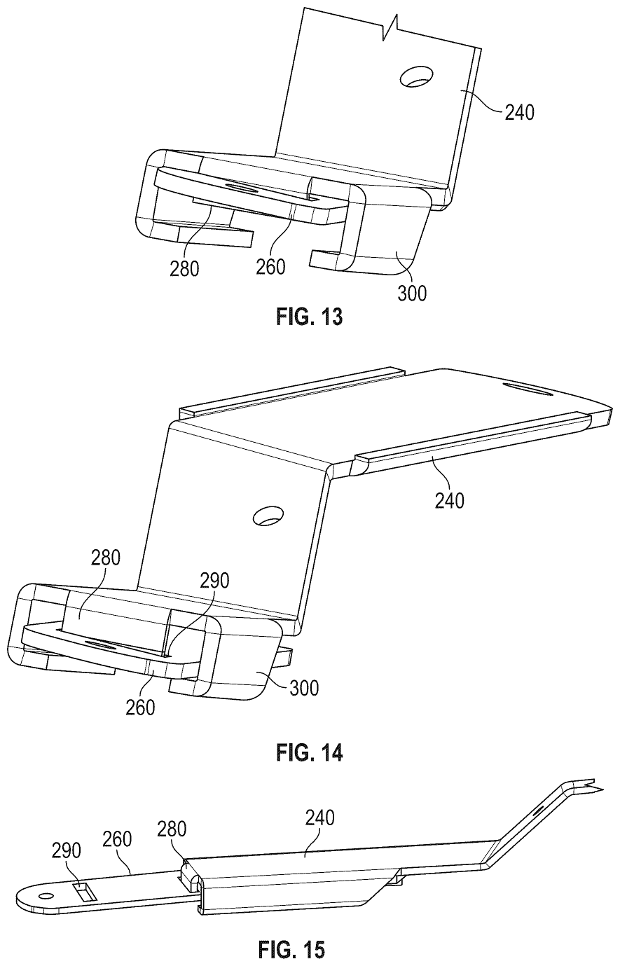

FIGS. 12 and 13 show a portion of the door synchronizing mechanism 190 of FIG. 7 in the second configuration. FIG. 14 shows the portion of the door synchronizing mechanism 190 of FIG. 7 in the first configuration. FIG. 15 shows the portion of the door synchronizing mechanism 190 of FIG. 7 in the first configuration with components separated.

In the embodiment shown, the insertion of the removable divider 200 into the primary internal cavity 150 triggers or executes a transition of the cooking appliance 100 from the second configuration to the first configuration. Similarly, the removal of the removable divider 200 triggers or executes a transition of the cooking appliance 100 from the first configuration to the second configuration.

As shown, the insertion of the removable divider physically decouples mechanical components to disengage the door synchronizing mechanism 190. Accordingly, the door synchronizing mechanism 190 shown comprises a central linkage 230. The central linkage links a first rigid elongated element 240 extending towards the hinged outer edge 170 of the first door 110 and a second rigid elongated element 250 extending towards the hinged outer edge 180 of the second door 120.

The hinged outer edge 170 of the first door 110 and the hinged outer edge 180 of the second door 120 each comprise a corresponding engagement element 260, 270 for receiving and engaging with the corresponding rigid elongated element 240, 250. The insertion of the removable divider 200 then disengages the door synchronizing mechanism by decoupling the corresponding rigid elongated element 240, 250 from the corresponding engagement element 260, 270.

It is understood that while the embodiment shown shows two engagement elements 260, 270, each fixed to a corresponding door 110, 120, and each configured for coupling with a corresponding rigid elongated element 240, 250, in some embodiments, only a single engagement and disengagement is necessary. Accordingly, in some embodiments, only one door is provided with an engagement element while the other is fixed directly to the corresponding rigid elongated element. In such an embodiment, once decoupled, one of the doors remains linked to the central linkage 230 by way of the corresponding rigid elongated element. However, because the second door is decoupled in the first configuration, the movement of the central linkage with the first door would no longer impact the movement of the second door.

As shown in FIG. 6, when in the second configuration, the cooking appliance 100 utilizes the door synchronizing mechanism 190 in its engaged configuration to synchronize the opening of the doors 110, 120, such that when the second door 120 is opened by a user, the corresponding engagement element 270 moves the corresponding rigid elongated element 250 which in turn moves the central linkage 230 which then opens the first door 110 by way of the other rigid elongated element 240 and engagement element 260. FIG. 7 then shows the engagement element 260 fully engaged, such that the rigid elongated element 240 moves with the engagement element.

FIGS. 8 and 9 show the insertion of the removable divider 200. Once the removable divider 200 is inserted, the doors 210, 220 are decoupled, either immediately, or following a closure of the doors. FIG. 10 then shows the engagement element 260 decoupled from the rigid elongated element 240.

In the embodiment shown, the rigid elongated element 240 functions as a primary coupling element and the corresponding engagement element 260 functions as a secondary couple element. The primary coupling element then rests above the secondary coupling element. The primary coupling element 240 then includes a tab 280 for engaging a slot 290 in the secondary coupling element 260. Because the primary coupling element 240 is above the secondary coupling element 260, the tab 280 can drop into the slot and the coupling can engage gravitationally when unobstructed. Accordingly, when unobstructed, the rigid elongated element 240 couples with the engagement element 260. In contrast, when obstructed, as described in more detail below, the rigid elongated element 240 and the engagement element 260 are decoupled.

It is understood that in some embodiments, other coupling configurations are utilized, such that positions of the coupling elements can be reversed or inverted. Similarly, the mechanism taken as a whole may be inverted, such that an unobstructed configuration results in the coupling being decoupled while an obstructed configuration results in coupling.

As shown, one of the coupling elements, here the primary coupling element in the form of the first elongated element 240, further comprises a sleeve 300 for at least partially enclosing and allowing for translation of the secondary coupling element, here the engagement element 260, when not coupled. This allows for the elements to move relative to each other while maintaining alignment, as well as providing a surface by which the corresponding elongated element 240 can be lifted relative to the corresponding engagement element 260.

Typically, only a short portion of the elongated elements 240, 250 comprise such a sleeve 300. Such a sleeve 300 is typically located at an engaging end 310 of the corresponding element 240, such that alignment can be maintained so long as the elements of the coupling 240, 260 are incorporated into the cooking appliance 100, even if not coupled. Furthermore, the sleeve 300 need not fully enclose the complementary element 260, and as such, may have a slot included. A longer sleeve 300 may be avoided, in order to avoid a need for an unnecessarily large space between the inner housing 140 and the outer housing 130 to accommodate a thicker elongated element 240, 250.

This is shown in FIGS. 12-15, where FIGS. 12 and 13 show the first elongated element 240 fully engaged with the engagement element 260. In the configuration shown, the elongated element 240 is unobstructed, and as such, the tab 280 is gravitationally inserted into slot 290 and the end of the elongated element 240 rests on the corresponding engagement element 260.

As shown in FIG. 14, tab 280 may be removed from slot 290, thereby disengaging the elongated element 240 from the engagement element 260. However, the engagement element 260 may still be retained by the sleeve 300 in the disengaged configuration. Accordingly, as shown in FIG. 15, the engagement element 260 may translate within the sleeve 300 while disengaged from the elongated element 240, thereby maintaining alignment of the components.

FIG. 14 shows the elongated element 240 lifted relative to the engagement element 260. This may be facilitated by the sleeve 300. Accordingly, a lifting element 320, or pair of lifting elements 320, 330, may be provided for lifting the primary coupling elements, in this case the elongated elements 240, 250 relative to the secondary coupling elements, in this case the engagement elements 260, 270 upon insertion of the removable divider 200.

The lifting of the primary coupling elements 240, 250 by the lifting elements 320, 330 may be by way of the corresponding sleeves 300. Accordingly, the lifting elements 320, 330 are positioned below the respective primary coupling elements 240, 250 and the secondary coupling elements 260, 270, and lift the primary coupling elements through contact with their respective sleeves.

As shown, the lifting elements 320, 330 may comprise rotatable blades 340, 350 extending from corresponding handles 360, 370 which are mechanically rotated into a lifting configuration by a portion 380 of the removable divider 200 upon insertion of the removable divider. For example, the portion may be a tab 380 extending upwards from the divider, and the tab may directly push the handles 260, 370 such that the rotatable blades are rotated into their lifting configurations.

This transition is shown in FIGS. 8 and 9, and FIG. 9 shows the lifting elements 320, 330 in their lifting configurations. In FIG. 8, the divider 200 with the tab 380 is being inserted into the primary internal cavity 150, and the lifting elements 320, 330 are shown disengaged, such that they do not impact the sleeve 300 of the elongated element 240. A housing slot 390 is visible in the inner housing 140 of the cooking appliance for receiving the tab 380 when the divider 200 is fully inserted. As shown in FIG. 9, the tab 380 then enters the slot and impinges on the handles 360, 370 of the corresponding lifting elements 320, 330.

In the embodiment shown, the lifting elements 320, 330 are symmetric, such that both primary coupling elements 240, 250 are decoupled form the corresponding secondary coupling elements 260, 270 upon insertion of the removable divider 200. As also shown, in the decoupled configuration, the lifting elements 320, 330 extend substantially linearly, and the rotatable blades 340, 350 rotate towards the hinged edges 170, 180 of the respective doors 110, 120.

In the embodiment shown, the rotatable blades 340, 350 of the lifting elements 320, 330 are biased against the lifting configuration. Accordingly, when not retained by the presence of the removable divider, the two lifting elements 320, 330 rotate away from their respective lifting configurations. However, as noted above, this relationship could be inverted, such that the lifting elements are biased towards the lifting configuration, and the mechanism itself is inverted, such that the lifting configuration forces a coupling and retracting the lifting elements results in a decoupled configuration.

It is further noted that the lifting elements 320, 330 may be provided with grooves or tracks 400, 410 to insure that when impinged by the tab 380 of the divider, the handles 360, 370 of the lifting elements follow a predetermined path. Such an approach allows for additional precision in determining whether the door synchronizing mechanism 190 is to be coupled or decoupled at any particular time and in any configuration.

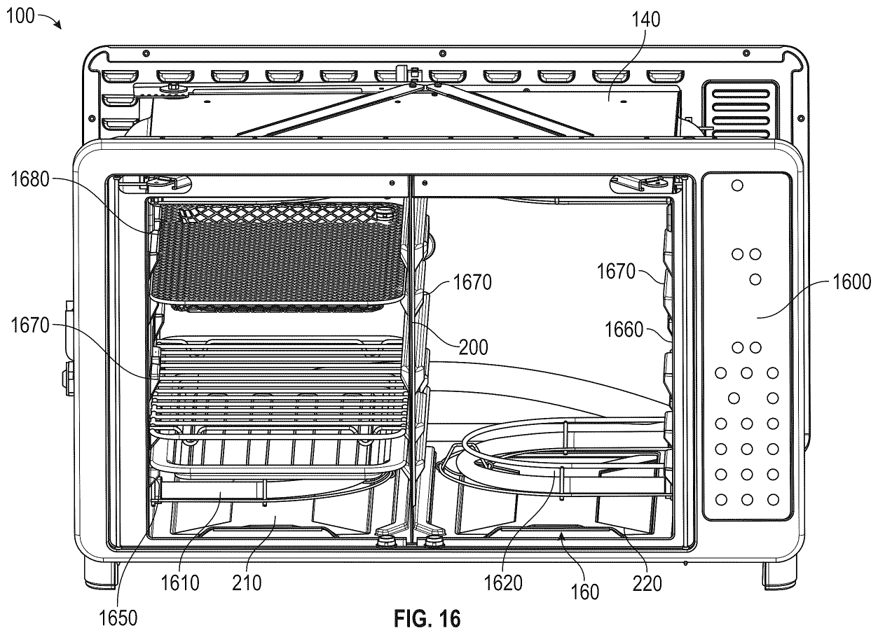

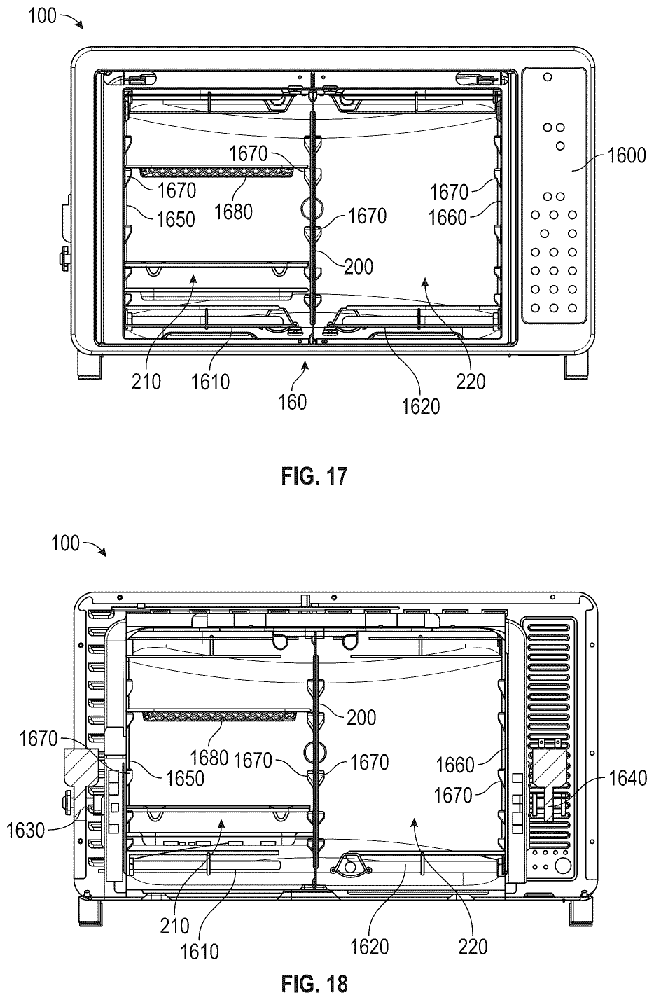

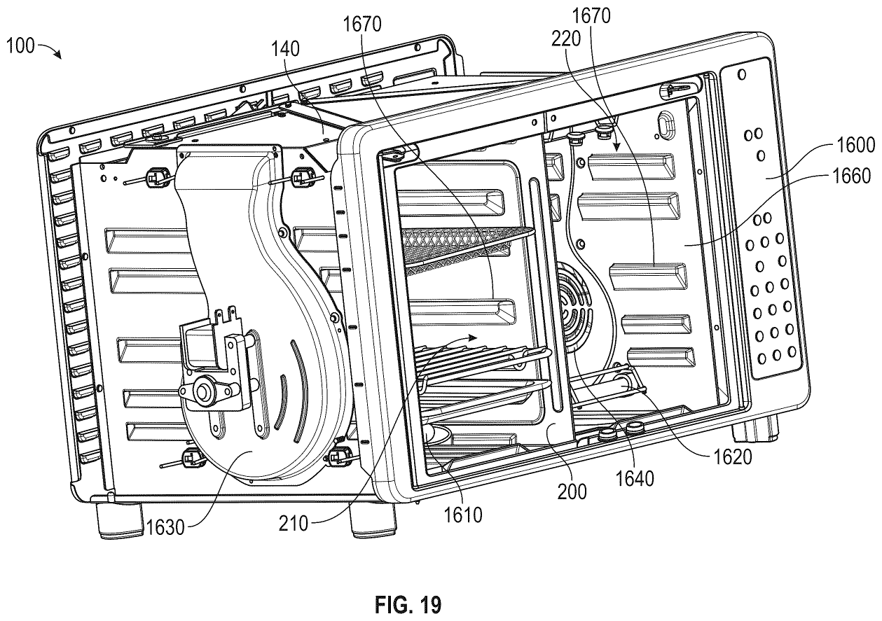

FIGS. 16 and 17 show the cooking appliance 100 of FIG. 1 with the doors 110, 120 and outer housing 130 removed. FIG. 18 shows a sectioned view of the cooking appliance 100 of FIG. 1. FIG. 19 shows a perspective view of the cooking appliance 100 of FIG. 1 with the outer housing 130 removed.

As shown, the cooking appliance 100 is provided in the second configuration. During use, the cooking appliance 100 may utilize electronic circuitry for controlling cooking operation of the cooking appliance. Such electronic circuitry is not shown in the drawings, but may be controlled or accessed by way of the control panel 1600 shown, and may be accommodated in a space behind such control panel.

The electronic circuitry 1600 may determine whether the removable divider 200 is present within the primary internal cavity 150, thereby determining whether the cooking appliance is in the first configuration or the second configuration. Upon determining that the cooking appliance 100 is in the first configuration in which the removable divider 200 is present, the electronic circuitry 1600 may operate the first divided internal cavity 210 and second divided internal cavity 220 independently.

The determination made by the electronic circuitry 1600 may be in addition to or in place of the mechanical transition discussed above. Accordingly, in some embodiments, the mechanical transition implemented to engage or disengage the door synchronizing mechanism 190 may function to control the behavior of the doors 110, 120 and may do nothing to control the cooking behavior of the components of the cooking appliance 100. Alternatively, the mechanical mechanism discussed above may be omitted, and the electronic circuitry 1600 may be utilized to determine whether the cooking appliance 100 is in the first configuration with the removable divider 200 inserted, and may therefore trigger a transition to disengage the door synchronizing mechanism 190. Similarly, the electronic circuitry 1600 may, upon determining that the removable divider 200 has been removed, trigger a transition to engage the door synchronizing mechanism 190.

Further, the cooking appliance 100 may comprise a first heating element 1610 associated with the first divided internal cavity 210 and a second heating element 1620 associated with the second divided internal cavity 220. Upon determining that the cooking appliance 100 is in the first configuration, the electronic circuitry 1600 may function to independently control the first and second heating elements 1610, 1620.

Similarly, the cooking appliance 100 may comprise a first air circulation fan 1630 within or associated with the first divided internal cavity 210 and a second air circulation fan 1640 within or associated with the second divided internal cavity 220. Upon determining that the cooking appliance 100 is in the first configuration, the electronic circuitry 1600 may independently control the first and second air circulation fans 1630, 1640.

In contrast, if the electronic circuitry 1600 determines that the cooking appliance 100 is in the second configuration, and that the removable divider 200 is not present, the electronic circuitry may instead control the first heating element 1610 and the second heating element 1620 in concert in order to regulate a temperature of the primary internal cavity 150. Similarly, the electronic circuitry 1600 may control the first and second air circulation fans 1630, 1640 in concert to control airflow within the primary internal cavity 150.

In this manner, when the cooking appliance 100 is in the first configuration, resulting in two discrete divided internal cavities 210, 220, each cavity may be controlled independently in order to provide two different cooking temperatures. Similarly, where a fan is provided to support convection or air frying features, the discrete cooking cavities may provide independent controls for such features. In some embodiments, only one air circulation fan may be provided on one side of the inner housing 140 or the other. In such an embodiment, once divided in the first configuration, only one of the divided internal cavities 210, 220 may be provided with such convection or air frying features. In yet other embodiments, such a fan may not be provided or may be centrally located, such that once divided, such features may not be available.

Additional features may be implemented by way of the removable divider 200 to distinguish between the first configuration and the second configuration. As shown, in the context of the primary internal cavity 150, sidewalls 1650, 1660 may be provided with shelves 1670 for supporting various types of racks for holding contents within the cavity. When in the second configuration, racks would extend from shelves 1670 on the first sidewall 1650 to shelves on the second sidewall 1660. The removable divider 200 may be similarly provided with shelves 1670, such that smaller racks 1680 may be held in place when the cooking appliance 100 is in the first configuration.

It is further noted that the removable divider 200 may be insulated, so as to allow the cooking appliance 100 to cook at discrete temperatures within each of the first and second divided internal cavities 210, 220.

During use, a method may be utilized to convert the cooking appliance 100 described herein between a single oven, shown in the second configuration, and a double oven, shown in the first configuration.

As shown, a cooking appliance 100 is provided having an inner housing 140 defining a primary internal cavity 150. Two doors 110, 120 are provided for closing an opening 160 of the primary internal cavity 150 of the cooking appliance. Each door 110, 120 has a hinged outer edge 170, 180 at which the corresponding door pivots relative to the inner housing 140.

A door synchronizing mechanism 190 is provided for linking the two doors 110, 120, thereby synchronizing the opening or closing of the two doors when the door synchronizing mechanism is engaged.

A removable divider 200 is provided for dividing the primary internal cavity 150 into a first divided internal cavity 210 and a second divided internal cavity 220. The removable divider 200 is then inserted within the primary cavity 150 such that a portion of the removable divider 200 impacts a component of the door synchronizing mechanism 190. The removable divider 200 also divides the primary internal cavity 150 into a first divided internal cavity 210 and the second divided internal cavity 220.

As a result of the impact of the removable divider 200 on the component of the door synchronizing mechanism 190, the door synchronizing mechanism is decoupled. Accordingly, a user may then open or close a first door 110 of the two doors 110, 120 independently of a second door 120 of the two doors.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A cooking appliance comprising:
a housing having a primary internal cavity;
two doors for closing an opening of the primary internal cavity, each door having a hinged outer edge at which the corresponding door pivots relative to the housing;
a door synchronizing mechanism for linking the two doors, thereby synchronizing the opening or closing of the two doors when the door synchronizing mechanism is engaged; and
a removable divider for dividing the primary internal cavity into a first divided internal cavity and a second divided internal cavity,
wherein, in a first configuration, the removable divider is present and the door synchronizing mechanism is disengaged such that the two doors open and close independently, and in a second configuration, the removable divider is removed and the door synchronizing mechanism is engaged.

2. The cooking appliance of claim 1, wherein insertion of the removable divider triggers or executes a transition of the cooking appliance from the second configuration to the first configuration, and wherein removal of the removable divider triggers or executes a transition of the cooking appliance from the first configuration to the second configuration.

3. The cooking appliance of claim 2, wherein insertion of the removable divider physically decouples mechanical components to disengage the door synchronizing mechanism.

4. The cooking appliance of claim 3, wherein the door synchronizing mechanism comprises a central linkage linking a first rigid elongated element extending towards the hinged outer edge of the first door and a second rigid elongated element extending towards the hinged outer edge of the second door, and wherein at least one of the first hinged outer edge and the second hinged outer edge comprises an engagement element for receiving and engaging with the corresponding rigid elongated element, and wherein the insertion of the removable divider disengages the door synchronizing mechanism by decoupling the corresponding rigid elongated element from the corresponding engagement element.

5. The cooking appliance of claim 4, wherein one of the rigid elongated element and the corresponding engagement element is a primary coupling element and rests above a secondary coupling element comprising the other of the rigid elongated element and the corresponding engagement element and the primary coupling element comprises a tab for engaging a slot in the secondary coupling element, such that the primary coupling element engages the secondary coupling element gravitationally when unobstructed, thereby coupling the corresponding rigid elongated element and the corresponding engagement element.

6. The cooking appliance of claim 5, wherein the primary coupling element further comprises a sleeve for at least partially enclosing and allowing for translation of the secondary coupling element when not coupled.

7. The cooking appliance of claim 6 further comprising a lifting element for lifting the primary coupling element relative to the secondary coupling element upon insertion of the removable divider.

8. The cooking appliance of claim 7, wherein the primary coupling elements further comprises a sleeve for at least partially enclosing and allowing for translation of the secondary coupling element when not coupled, and wherein the lifting element is positioned below both the primary coupling element and the secondary coupling element and lifts the primary coupling element through contact with the sleeve.

9. The cooking appliance of claim 7 wherein the lifting element comprises a rotating blade which is mechanically rotated into a lifting configuration by a portion of the removable divider upon insertion of the removable divider.

10. The cooking appliance of claim 9 wherein both of the first and second rigid elongated elements couple with the corresponding engagement elements, and wherein the lifting element comprises two rotatable blades arranged substantially symmetrically such that both primary coupling elements are decoupled from the corresponding secondary coupling elements upon insertion of the removable divider.

11. The cooking appliance of claim 9, wherein the rotatable blade is biased against the lifting configuration, such that the rotatable blade rotates away from the lifting configuration when not retained by the presence of the removable divider.

12. The cooking appliance of claim 1 further comprising electronic circuitry for controlling cooking operation of the cooking appliance, wherein the cooking appliance determines whether the removable divider is present within primary internal cavity thereby determining whether the cooking appliance is in the first configuration or the second configuration and, upon determining that the cooking appliance is in the first configuration, operating the first divided internal cavity and the second divided internal cavity independently.

13. The cooking appliance of claim 12 further comprising a first heating element within the first divided internal cavity and a second heating element within the first divided internal cavity, and wherein, upon determining that the cooking appliance is in the first configuration, the electronic circuitry independently controls the first heating element and the second heating element.

14. The cooking appliance of claim 13 further comprising a first air circulation fan within or associated with the first divided internal cavity and a second air circulation fan within or associated with the second divided internal cavity, and wherein, upon determining that the cooking appliance is in the first configuration, the electronic circuitry independently controls the first air circulation fan and the second air circulation fan.

15. The cooking appliance of claim 13, wherein upon determining that the cooking appliance is in the second configuration, the electronic circuitry controls the first heating element and the second heating element in concert to regulate a temperature of the primary internal cavity.

16. A method for converting a cooking appliance between single oven and double oven configurations comprising:
providing a cooking appliance having a housing with a primary internal cavity;
providing two doors for closing an opening of the primary internal cavity of the cooking appliance, each door having a hinged outer edge at which the corresponding door pivots relative to the housing;
providing a door synchronizing mechanism for linking the two doors, thereby synchronizing the opening or closing of the two doors when the door synchronizing mechanism is engaged; and
providing a removable divider for dividing the primary internal cavity into a first divided internal cavity and a second divided internal cavity;
inserting the removable divider within the primary internal cavity such that a portion of the removable divider impacts a component of the door synchronizing mechanism, and such that the removable divider divides the primary internal cavity into a first divided internal cavity and a second divided internal cavity;
decoupling the door synchronizing mechanism as a result of the impact of the removable divider; and
opening or closing a first door of the two doors independently of a second door of the two doors.

17. The method of claim 16 wherein the door synchronizing mechanism further comprising at least one rotatable decoupling blade having a decoupling configuration in which the door synchronizing mechanism is decoupled and a coupling configuration in which the door synchronizing mechanism is coupled, and wherein the at least one decoupling blade is biased towards the coupling configuration, and wherein the portion of the removable divider impacts an extension of the at least one rotatable decoupling blade, thereby rotating the decoupling blade into the decoupling configuration.
